(19) United States
(12) Patent Application Publication
(10) Pub. No.: US 2025/0037216 A1
(43) Pub. Date: Jan. 30, 2025

(54) METHODS AND INTERNET OF THINGS SYSTEMS FOR MONITORING SMART GAS PIPELINE NETWORK CONSTRUCTION

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Xiaojun WEI, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 18/912,546

(22) Filed: Oct. 10, 2024

(30) Foreign Application Priority Data
Aug. 14, 2024 (CN) 202411114079.0

(51) Int. Cl. G06Q 50/06; G06Q 10/0635; G06Q 30/018; G06Q 50/08

(52) U.S. Cl. CPC G06Q 50/06; G06Q 10/0635; G06Q 30/018; G06Q 50/08

(57) ABSTRACT

A method and an Internet of Things (IoT) system for monitoring smart gas pipeline network construction are provided. The method is performed by a smart gas government supervision and management platform, including obtaining, in response to construction information being updated, supervisory data of a construction supervision area; determining a construction state of a construction pipeline; in response to the construction state meeting a first condition, generating a material transportation instruction based on the construction information and environmental data; in response to the construction state meeting a second condition, generating a gas supply regulation instruction of the construction supervision area based on at least one of the construction information, the environmental data, and gas usage data; obtaining a first update frequency of the material transportation instruction; and adjusting a current monitoring parameter of the smart gas equipment object platform based on the first update frequency and a second update frequency.

### CROSS-REFERENCE TO RELATED APPLICATIONS

This application claims priority to Chinese Patent Application No. 202411114079.0, filed on Aug. 14, 2024, the entire contents of which are hereby incorporated by reference.

### TECHNICAL FIELD

The present disclosure relates to a technical field of gas pipeline network operation, and in particular, to methods and Internet of Things (IoT) systems for monitoring smart gas pipeline network construction.

### BACKGROUND

With the accelerated development of urbanization, gas, as an indispensable energy source for urban life and industrial production, may encounter delays in the gas pipeline construction due to the impact of traffic, material deployment, weather, or the like. The gas pipeline construction also affects transportation and gas supply.

In traditional management of the gas pipeline network, there is often a lack of assessment of the potential factors affecting construction, as well as a failure to consider the impact of gas pipeline construction on gas supply, which may result in low construction efficiency and even affect the stability of gas supply.

In view of the foregoing, it is desirable to provide a method and an Internet of Things (IoT) system for monitoring smart gas pipeline network construction to better monitor the gas pipeline construction.

### SUMMARY

Some embodiments of the present disclosure provide a method for monitoring smart gas pipeline network construction. The method is performed by a smart gas government supervision and management platform of an Internet of Things (IoT) system for monitoring smart gas pipeline network construction, and the method comprises: obtaining update situation of construction information corresponding to a construction pipeline in a construction supervision area, and obtaining, in response to determining that the construction information is updated, supervisory data of the construction supervision area; storing the supervisory data in a government supervisory integrated database of the smart gas government supervision and management platform according to a preset rule, the government supervisory integrated database being configured as a memory, the supervisory data including the construction information, environmental data of the construction supervision area, and gas usage data of a pipeline to be constructed in the construction supervision area; determining a construction state of the construction pipeline; in response to the construction state meeting a first condition, generating a material transportation instruction for the construction pipeline based on the construction information and the environmental data; and sending the material transportation instruction to a transportation device to control the transportation device to transport material according to a material transportation parameter; in response to the construction state meeting a second condition, generating a gas supply regulation instruction of the construction supervision area based on at least one of the construction information, the environmental data, and the gas usage data; and sending the gas supply regulation instruction to a smart gas equipment object platform corresponding to the construction supervision area to control a gas supply parameter in the construction supervision area; obtaining a first update frequency of the material transportation instruction and a second update frequency of the gas supply regulation instruction from the government supervisory integrated database; adjusting a current monitoring parameter of the smart gas equipment object platform based on the first update frequency and the second update frequency; allocating a size of a storage partition occupied by the supervisory data and gas safety data in the government supervisory integrated database based on an adjusted monitoring parameter; and determining a priority of calculating resource allocation when a processor of the smart gas government supervision and management platform processes different types of data.

Some embodiments of the present disclosure also provide an Internet of Things (IoT) system for monitoring smart gas pipeline network construction. The IoT system includes a smart gas government supervision and management platform, a smart gas government supervision sensing network platform, a smart gas government supervision object platform, a smart gas company sensing network platform, a smart gas equipment object platform, and a gas user object platform. The smart gas government supervision and management platform includes a government supervisory integrated database. The smart gas government supervision object platform includes a smart gas company management platform. The smart gas government supervision and management platform is configured to obtain update situation of construction information corresponding to a construction pipeline in a construction supervision area, and obtain, in response to determining that the construction information is updated, supervisory data of the construction supervision area; store the supervisory data in a government supervisory integrated database of the smart gas government supervision and management platform according to a preset rule, the government supervisory integrated database being configured as a memory, the supervisory data including the construction information, environmental data of the construction supervision area, and gas usage data of a pipeline to be constructed in the construction supervision area and determine a construction state of the construction pipeline; in response to the construction state meeting a first condition, generate a material transportation instruction for the construction pipeline based on the construction information and the environmental data and send the material transportation instruction to a transportation device to control the transportation device to transport material according to a material transportation parameter; in response to the construction state meeting a second condition: generate a gas supply regulation instruction of the construction supervision area, based on at least one of the construction information, the environmental data, and the gas usage data; and send the gas supply regulation instruction to a smart gas equipment object platform corresponding to the construction supervision area to control a gas supply parameter in the construction supervision area; obtain a first update frequency of the material transportation instruction and a second update frequency of the gas supply regulation instruction from the government supervisory integrated database; adjust a current monitoring parameter of the smart gas equipment object platform based on the first update frequency and the second update frequency; allocate a size of a storage partition occupied by the supervisory data and gas safety data in the government supervisory integrated database, based on an adjusted monitoring parameter; and determine a priority of calculating resource allocation when a processor of the smart gas government supervision and management platform processes different types of data.

### BRIEF DESCRIPTION OF THE DRAWINGS

The present disclosure may be further described in terms of exemplary embodiments, which may be described in detail with reference to the drawings. These embodiments are not limiting, and in these embodiments, the same reference numerals in the various drawings represent similar structures, wherein:

FIG. 1 is a schematic diagram illustrating an Internet of Things (IoT) system for monitoring smart gas pipeline network construction according to some embodiments of the present disclosure;

FIG. 2 is a flowchart illustrating an exemplary method for monitoring smart gas pipeline network construction according to some embodiments of the present disclosure;

FIG. 3 is a schematic diagram illustrating determining a material transportation instruction according to some embodiments of the present disclosure;

FIG. 4 is a schematic diagram illustrating updating a construction plan according to some embodiments of the present disclosure; and

FIG. 5 is a schematic diagram illustrating determining a gas supply regulation instruction according to some embodiments of the present disclosure.

### DETAILED DESCRIPTION

In order to more clearly illustrate the technical solutions of the embodiments of the present disclosure, the accompanying drawings required to be used in the description of the embodiments will be briefly described below. The accompanying drawings in the following description are obviously only some examples or embodiments of the present disclosure, and it is possible for a person of ordinary skill in the art to apply the present disclosure to other similar scenarios based on these drawings without creative labor. Unless obviously obtained from the context or the context illustrates otherwise, the same numeral in the drawings refers to the same structure or operation.

It should be understood that “system”, “device”, “unit” and/or “module” as used herein is a manner used to distinguish different components, elements, parts, sections, or assemblies at different levels. However, if other words can achieve the same purpose, the words may be replaced by other expressions.

Unless the context clearly suggests an exception, the words “one”, “a”, “a kind” and/or “the” do not specifically refer to the singular but may also include the plural. Generally, the terms “comprise”, “comprises”, “comprising”, “include”, “includes”, and/or “including” suggest only the inclusion of explicitly identified steps and elements, which do not constitute an exclusive list. The method or device may also include other operations or elements.

Flowcharts are used in the present disclosure to illustrate operations performed by a system according to some embodiments of the present disclosure. It should be appreciated that the preceding or following operations are not necessarily performed in an exact sequence. Instead, steps can be processed in reverse order or simultaneously. Meanwhile, other operations may also be added to these processes, or a certain step or several steps may be removed from these processes.

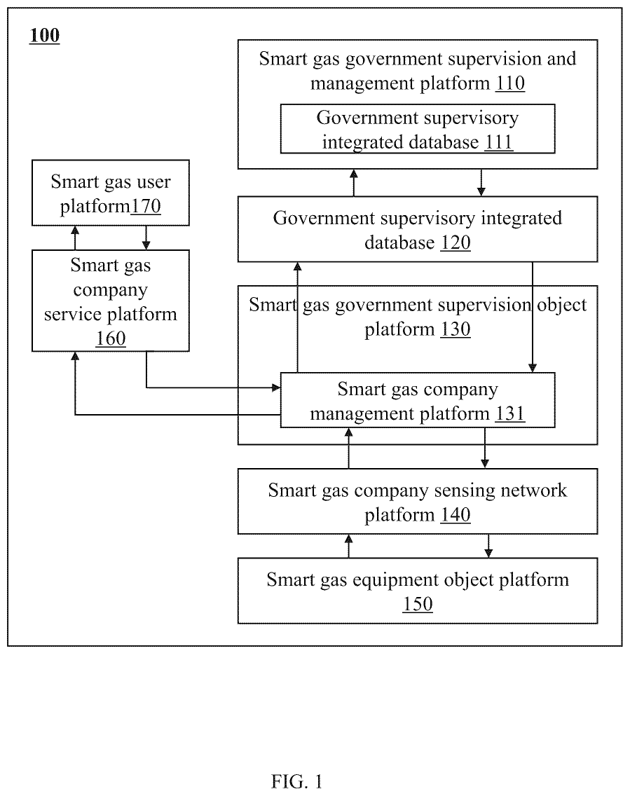

FIG. 1 is a schematic diagram illustrating an Internet of Things (IoT) system for monitoring smart gas pipeline network construction according to some embodiments of the present disclosure. The IoT system for monitoring smart gas pipeline network construction covered by the embodiments of the present disclosure will be described in detail below. It should be noted that the following embodiments are used only to explain the present disclosure and do not constitute a limitation of the present disclosure.

In some embodiments, as shown in FIG. 1, an IoT system 100 for monitoring smart gas pipeline network construction (referred to as the IoT system 100 hereinafter) includes a smart gas government supervision and management platform 110, a smart gas government supervision sensing network platform 120, a smart gas government supervision object platform 130, a smart gas company sensing network platform 140, a smart gas equipment object platform 150, and a gas user object platform 160.

The smart gas government supervision and management platform 110 is a platform for a government user to supervise the gas network. The supervision includes but is not limited to a gas pipeline construction. The government user may be a superior administrative authority (e.g., the housing and urban-rural development bureau) of the gas operating entity, etc.

In some embodiments, the smart gas government supervision and management platform 110 may interact with the smart gas government supervision sensing network platform 120 for data. For example, the smart gas government supervision and management platform 110 may obtain environmental data of a construction supervision area via the smart gas government supervision sensing network platform 120.

In some embodiments, the smart gas government supervision and management platform 110 may include a government supervisory integrated database 111.

The government supervisory integrated database 111 is configured to store and manage various types of data generated by the government user in the process of supervising gas pipeline networks. For example, the data generated by the government user in the process of supervising gas pipeline networks may be information related to the gas pipeline construction, or the like. In some embodiments, the government supervisory integrated database 111 may be configured as a storage device for storing data related to the gas pipeline construction. For example, the data related to the gas pipeline construction may include construction information, environmental data of the construction supervision area, or the like. In some embodiments, the government supervisory integrated database 111 is only available to the government user.

In some embodiments, the smart gas government supervision and management platform 110 may further include a processor. The processor is configured to process data related to the IoT system 100. In some embodiments, the processor may be configured to obtain update situation of the construction information corresponding to a construction pipeline in the construction supervision area, and obtain, in response to determining that the construction information is updated, supervisory data of the construction supervision area; store the supervisory data in the government supervisory integrated database of the smart gas government supervision and management platform according to a preset rule; determine a construction state of the construction pipeline; in response to the construction state meeting a first condition, generate a material transportation instruction for the construction pipeline based on the construction information and the environmental data; and send the material transportation instruction to a transportation device to control the transportation device to transport material according to a material transportation parameter; in response to the construction state meeting a second condition, generate a gas supply regulation instruction of the construction supervision area based on at least one of the construction information, the environmental data, and the gas usage data; and send the gas supply regulation instruction to the smart gas equipment object platform corresponding to the construction supervision area to control a gas supply parameter in the construction supervision area; obtain a first update frequency of the material transportation instruction and a second update frequency of the gas supply regulation instruction from the government supervisory integrated database; adjust a current monitoring parameter of the smart gas equipment object platform based on the first update frequency and the second update frequency; allocate a size of a storage partition occupied by the supervisory data and gas safety data in the government supervisory integrated database based on an adjusted monitoring parameter; and determine a priority of calculating resource allocation when a processor of the smart gas government supervision and management platform processes different types of data.

The smart gas government supervision sensing network platform 120 may be a functional platform for managing sensing communications. In some embodiments, the smart gas government supervision sensing network platform 120 may be a functional platform that achieves the functions of sensing information sensing communications and control information sensing communications.

In some embodiments, the smart gas government supervision sensing network platform 120 may be configured to interact with the smart gas government supervision and management platform 110 and a smart gas company management platform 131.

The smart gas government supervision object platform 130 may be a functional platform configured to generate government supervision information and execute control information.

In some embodiments, the smart gas government supervision object platform 130 may include the smart gas company management platform 131.

The smart gas company management platform 131 is a platform for gas companies to manage the gas pipeline network. In some embodiments, each gas company corresponds to a smart gas company management platform 131.

In some embodiments, the smart gas company management platform 131 may interact with the smart gas government supervision sensing network platform 120 and the smart gas company sensing network platform 140. For example, the smart gas company management platform 131 may obtain the material transportation instruction based on the smart gas government supervision sensing network platform 120. The smart gas company management platform 131 may also obtain the gas usage data based on the smart gas company sensing network platform 140.

In some embodiments, the smart gas company management platform 131 includes a smart gas data center.

The smart gas data center may be configured to store and manage the information related to the gas pipeline construction. In some embodiments, the smart gas data center may be configured as a storage device for storing the data related to the gas pipeline construction. For example, the gas pipeline construction may include the supervisory data, the gas safety data, or the like.

The smart gas company sensing network platform 140 may be a functional platform configured to manage the sensing communications. In some embodiments, the smart gas company sensing network platform 140 may be a functional platform for sensing information sensing communication and control information sensing communication.

In some embodiments, the smart gas company sensing network platform 140 may be configured to interact with the smart gas company management platform 131 and the smart gas equipment object platform 150.

The smart gas equipment object platform 150 may be configured as various types of gas pipeline network equipment and monitoring equipment. For example, the gas pipeline network equipment may include outdoor gas pipelines, valve control devices, gas storage tanks, pressure regulating devices, gas meters, indoor gas pipelines, or the like; and the monitoring equipment may include gas flow meters, pressure sensors, temperature sensors, or the like.

In some embodiments, the IoT system 100 may also include a smart gas company service platform 160 and a smart gas user platform 170.

The smart gas service platform 160 may be a platform configured to communicate the needs and control information of gas users.

The smart gas user platform 170 may be a platform configured to interact with the gas users. In some embodiments, the smart gas user platform 170 may be configured as a terminal device.

In some embodiments of the present disclosure, based on the IoT system 100, the operation of various functional platforms is coordinated and regulated to form a closed-loop of information operation, realizing the informatization and intelligence of monitoring the smart gas pipeline network construction.

It should be noted that the above description of the IoT system 100 and its modules is provided only for descriptive convenience and does not limit the present disclosure to the scope of the cited embodiments.

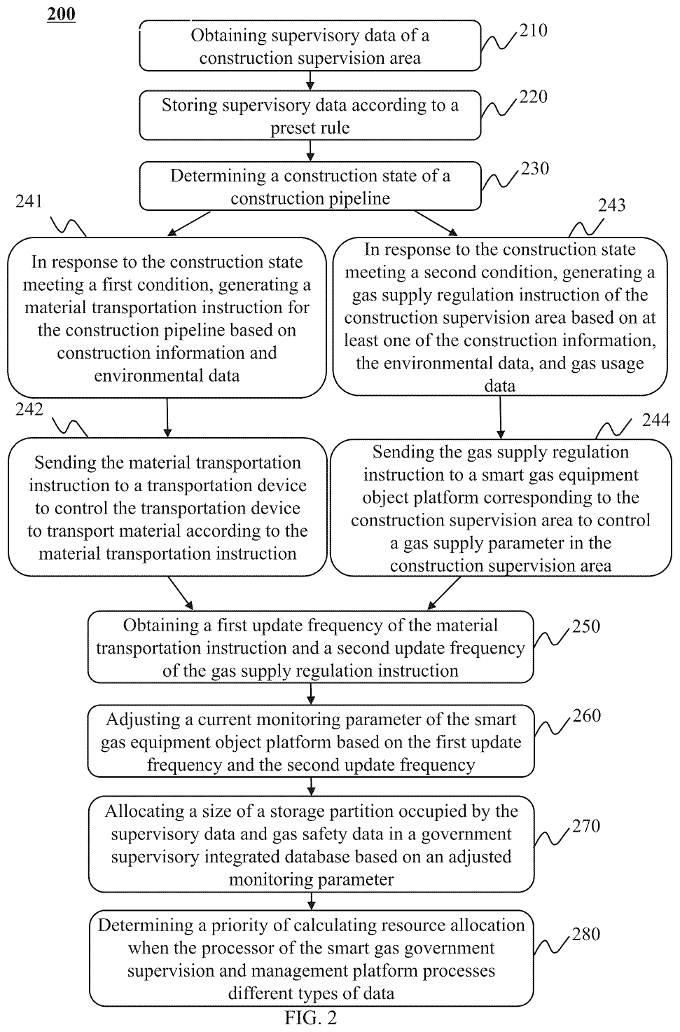

FIG. 2 is a flowchart illustrating an exemplary method for monitoring smart gas pipeline network construction according to some embodiments of the present disclosure. As shown in FIG. 2, process 200 includes the following steps. In some embodiments, the process 200 may be executed by a processor of the smart gas government supervision and management platform 110.

In 210, obtaining update situation of construction information corresponding to a construction pipeline in a construction supervision area, and obtaining, in response to determining that the construction information is updated, supervisory data of the construction supervision area.

The construction supervision area refers to an area where gas pipeline construction is supervised by the smart gas government supervision and management platform.

In some embodiments, the construction supervision area may be determined in a variety of ways. For example, the processor may delineate, based on administrative districts, to obtain the construction supervision area. As another example, each gas company may have a corresponding smart gas company management platform, which may obtain a construction situation of the gas pipeline that the company is responsible for and upload the construction situation to the smart gas government supervision and management platform via a smart gas government supervision sensing network platform. The processor may delineate the construction supervision area based on the construction situation of the gas pipeline for which each gas company is responsible.

The construction information is information related to the construction of the construction pipeline. For example, the construction information may include a construction pipeline code, a location, a construction volume (e.g., a length of the construction pipeline, etc.), a construction plan, a construction progress, or the like.

In some embodiments, the processor may obtain the construction information of the construction pipeline by accessing a government supervisory integrated database.

In some embodiments, due to policy adjustments or unexpected situations encountered during the construction process, the gas company may need to adjust the construction information and upload the adjusted construction information to the government supervisory integrated database to update the construction information. The update of the construction information may include update of the construction plan, update of the construction progress, or the like.

In some embodiments, the processor may determine whether the construction information is updated based on a read or write situation of data related to the construction information in the government supervisory integrated database.

In some embodiments, as the construction information is updated, the pipeline network construction monitoring also needs to be synchronized to meet supervision requirements of the latest construction pipeline.

The supervisory data is data obtained by supervising the gas pipeline in the construction supervision area. In some embodiments, the supervisory data includes the construction information, environmental data of the construction supervision area, and gas usage data corresponding to the gas pipeline in the construction supervision area.

The environmental data is data related to the environment around the construction pipeline. For example, the environmental data includes weather data, traffic flow data, pedestrian flow data, or the like, around the construction pipeline. In some embodiments, the processor may obtain the traffic flow data and the pedestrian flow data around the construction pipeline via monitoring devices in the construction supervision area and obtain the weather data around the construction pipeline via communication with a weather station.

The gas usage data refers to gas consumption data of gas pipelines at different times. For example, the gas usage data includes a gas usage time period, a gas usage, or the like. In some embodiments, the processor may obtain the gas usage data corresponding to the gas pipeline via a gas flow meter.

In 220, storing the supervisory data in the government supervisory integrated database of the smart gas government supervision and management platform according to a preset rule.

In some embodiments, in order to facilitate the management of the supervisory data, it is necessary to store the supervisory data in the government supervisory integrated database according to the preset rule. For example, the processor may store the supervisory data to the government supervisory integrated database in a chronological order.

In 230, determining a construction state of the construction pipeline.

The construction state refers to a construction stage in which the construction pipeline is located. In some embodiments, the construction state may be categorized as a pending construction stage and an under construction stage. The under construction stage may be further divided into a current process stage, such as excavation of a pipe trench, welding of pipe installation, and backfilling of the lower trench.

In some embodiments, the processor may read a current construction progress based on the current construction information of the construction pipeline to determine the construction state of the construction pipeline.

In 241, in response to the construction state meeting a first condition, generating a material transportation instruction for the construction pipeline based on the construction information and the environmental data.

The first condition is that the construction pipeline is in the pending construction stage. In the pending construction stage, the workers need to transport relevant materials to a designated location in advance. To ensure the smooth construction of the construction pipeline, it is necessary to set up a suitable time period for material transportation. The early transportation of materials may lead to issues such as material storage, site occupation, and traffic obstruction, while late transportation of materials may cause construction progress delays.

The material transportation instruction is an instruction that regulates material transportation. In some embodiments, the material transportation instruction may include a material transportation parameter. The material transportation parameter refers to a parameter related to the material transportation by a transportation device. For example, material transportation parameter may include a material transportation period, a material transportation volume, or the like.

Exemplarily, the material transportation instruction may include transporting 5 tons of stone to a specified location at 4:00 A.M. tomorrow.

In some embodiments, the processor may determine the material transportation instruction based on the construction information of the construction pipeline. For example, the processor may, based on the construction plan of the construction pipeline, in conjunction with a distance traveled by the material transportation, select a time period during which the environmental data meets the transportation requirements as the material transportation period. The processor may compute, based on the construction volume of the construction pipeline, the material transportation volume. The processor may generate, based on the material transportation period and the material transportation volume, the material transportation instruction. The environmental data meeting the transportation requirements may include that the weather data does not affect the transportation, the traffic flow data, and the pedestrian flow data that are less than a preset threshold, or the like.

In some embodiments, the processor may determine the material transportation volume based on a product of the construction volume of the construction pipeline and a preset factor. The preset factor is a value no less than 1, which may be determined based on historical experience or actual construction needs.

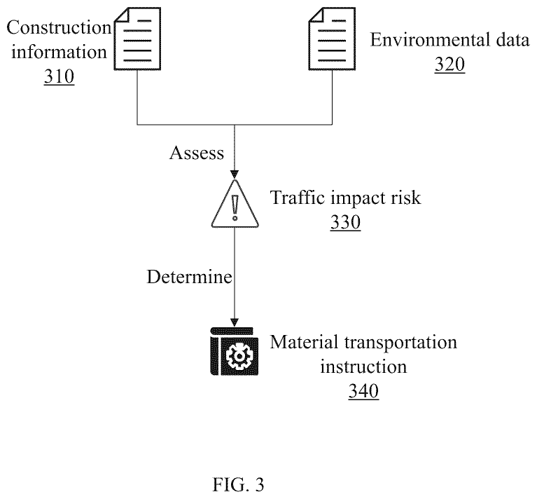

In some embodiments, the processor may also determine the material transportation instruction based on a traffic impact risk of the construction pipeline. More descriptions regarding the traffic impact risk may be found in FIG. 3 and related descriptions thereof.

In 242, sending the material transportation instruction to the transportation device to control the transportation device to transport material according to the material transportation instruction.

The transportation device is a device that transports materials to a specified location. For example, the transportation device includes cargo trucks, railroad wagons, cargo ships, air transportation devices, pipeline devices, or the like.

In some embodiments, the smart gas government supervision and management platform may send the material transportation instruction to a smart gas company management platform via the smart gas government supervision sensing network platform. The smart gas company management platform may then send, via the smart gas company sensing network platform, the material transportation instruction to the transportation device in a smart gas equipment object platform to control the transportation device to transport material according to the material transportation instruction.

In 243, in response to the construction state meeting a second condition, generating a gas supply regulation instruction of the construction supervision area based on at least one of the construction information, the environmental data, and the gas usage data.

The second condition is that the construction pipeline is in the under construction stage. The construction pipeline cannot be stopped once construction begins, and there may be risks such as gas outage and gas safety during the construction process, which may only be reduced by adjusting a gas supply parameter. For example, the processor may reduce the risk of gas outage by adjusting the gas supply parameter so that other gas supply devices replace the construction pipeline for gas supply. The processor may reduce the risk of gas safety by adjusting the air pressure and gas flow of the gas supply device.

The gas supply regulation instruction is an instruction that regulates parameters of different gas supply devices in the gas pipeline network. In some embodiments, the gas supply regulation instruction may include an alternative gas supply device, an alternative gas supply time period, a gas supply pressure, a gas supply flow rate, or the like. The alternative gas supply device refers to a device that replaces the construction pipeline for supplying gas to the gas user, such as a gas pipeline, a gas field station, or the like. The alternative gas supply time period refers to a time period when the alternative gas supply device replaces the construction pipeline for supplying gas to the gas user.

In some embodiments, the processor may designate, based on pipeline network information (pipeline network connection information, field station gas supply information, or the like), a gas supply device that connects to an affected gas user and supplies gas to the affected gas user as the alternative gas supply device. The construction pipeline is unable to supply gas to the gas user during the construction. The processor may designate, based on the construction information of the construction pipeline, the construction time period in the construction plan as the alternative gas supply time period. The processor may generate the gas supply regulation instruction for controlling the alternative gas supply device to supply gas during the alternative gas supply time period through at least one alternative gas supply device.

In some embodiments, the processor may also predict an alternative gas supply demand during the construction time period based on the gas usage data of the construction pipeline of a plurality of time periods in historical time. The processor may determine, based on the alternative gas supply demand during the construction time period, the gas supply flow rate and gas supply pressure of the alternative gas supply device, thereby determining the gas supply regulation instruction. The alternative gas supply demand refers to a demand associated with the gas supply to the gas user by the alternative gas supply device. In some embodiments, the higher the alternative gas supply demand, the higher the gas supply flow rate and gas supply pressure of the alternative gas supply device.

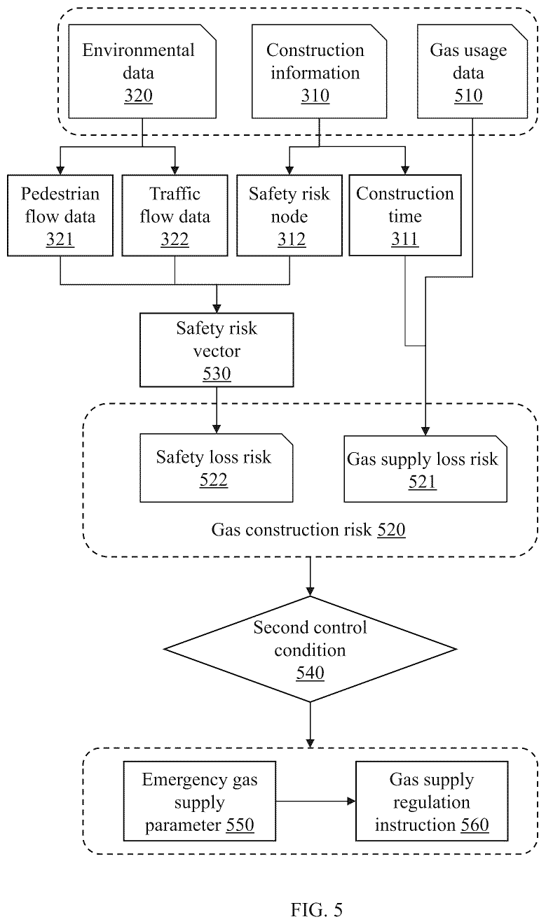

In some embodiments, the processor may also determine the gas supply regulation instruction based on a gas construction risk. More descriptions regarding the gas construction risk may be found in FIG. 5 and related descriptions thereof.

In 244, sending the gas supply regulation instruction to the smart gas equipment object platform corresponding to the construction supervision area to control the gas supply parameter in the construction supervision area.

The gas supply parameter is a parameter related to the gas supply to the gas supply device in the construction supervision area. For example, the gas supply parameter includes the gas supply flow rate, the gas supply pressure, or the like.

In some embodiments, the smart gas government supervision and management platform may send the gas supply regulation instruction to the smart gas company management platform via the smart gas government supervision sensing network platform. The smart gas company management platform may then send, via the smart gas company sensing network platform, the gas supply regulation instruction to the gas supply device in the smart gas equipment object platform to control the gas supply parameter in the construction supervision area.

In 250, obtaining a first update frequency of the material transportation instruction and a second update frequency of the gas supply regulation instruction from the government supervisory integrated database.

The first update frequency is a frequency at which the material transportation instruction is updated. For example, the first update frequency includes an update frequency of a material transportation instruction corresponding to at least one construction pipeline within the construction supervision area.

The second update frequency is a frequency at which the gas supply regulation instruction is updated. For example, the second update frequency includes an update frequency of gas supply parameters of one or more gas supply devices within the construction supervision area.

In some embodiments, the processor may obtain, via the government supervisory integrated database, the material transportation instructions received by a particular construction pipeline over a period of time compute a count of the material transportation instruction received per unit of time of the construction pipeline, and designate the count of the material transportation instruction as the first update frequency of the construction pipeline. The second update frequency is determined like the first update frequency.

In 260, adjusting a current monitoring parameter of the smart gas equipment object platform based on the first update frequency and the second update frequency.

The monitoring parameter is a frequency at which the monitoring device performs monitoring to obtain relevant data. In some embodiments, the monitoring device may include a gas safety monitoring device, a gas usage detection device, a site construction monitoring device, or the like.

The gas safety monitoring device is a device configured to obtain gas safety data. For example, the gas safety monitoring device may include a gas detector, a gas alarm, or the like.

The gas safety data is data that reflects the safety of the gas pipeline. For example, the gas safety data includes whether gas leakage is occurred in the gas pipeline, or the like.

The gas usage detection device is a device configured to obtain the gas usage data. For example, the gas usage detection device may include a gas meter, a barometric pressure sensor, or the like. Descriptions regarding the gas usage data may be found in related description hereinabove.

The site construction monitoring device is a device configured to obtain construction monitoring data, for example, the site construction monitoring device may include a camera, a television monitoring system, or the like.

The construction monitoring data refers to data obtained by monitoring the construction supervision area. For example, the construction monitoring data may include videos, images, or the like, of the construction site.

In some embodiments, when the first update frequency exceeds a first preset frequency threshold, the processor may increase the monitoring parameter of the site construction monitoring device to enhance the monitoring of the construction progress and ensure timely completion. The first preset frequency threshold may be determined based on historical experience.

When the second update frequency exceeds a second preset frequency threshold, the processor may increase the monitoring parameter of the gas safety monitoring device and the gas usage detection device to prevent exacerbated gas leakage and insufficient gas supply caused by the frequent updates of the gas supply parameter. The second preset frequency threshold may be determined based on historical experience.

In 270, allocating a size of a storage partition occupied by the supervisory data and gas safety data in the government supervisory integrated database based on an adjusted monitoring parameter.

In some embodiments, the higher the monitoring parameter of the monitoring device, the more pieces of data the monitoring device acquires. To avoid data loss caused by the data volume exceeding a storage space, the processor may allocate a larger storage partition for data corresponding to the monitoring device with a higher monitoring parameter and a smaller storage partition for data corresponding to the monitoring device with a lower monitoring parameter, thereby achieving reasonable utilization of the storage space.

In 280, determining a priority of calculating resource allocation when the processor of the smart gas government supervision and management platform processes different types of data.

When processing the data of the government supervisory integrated database, the processor may only perform a limited count of processing tasks at the same time due to computational resource limitations, such as handling up to three types of data simultaneously. Therefore, it is necessary to set priorities for different types of data so that the processor processes the higher-priority types of data first.

In some embodiments, the processor may calculate the time for the data volume reaching a storage partition alert line based on sizes of storage partitions, current occupied memory spaces, and data write rates of different types of data. The earlier the data volume for a certain type of data reaches the storage partition alert line, the higher the priority of resource allocation for that type of data. In some embodiments, the storage partition alert line may be set manually. For example, the storage partition alert line may be 75% of the storage partition capacity.

In some embodiments, as the monitoring parameter is constantly adjusted, the sizes of the storage partitions and data write rates of different types of data are also constantly changed, and the time for the data volume to reach the storage partition alert line is not fixed. Therefore, the processor needs to dynamically determine the priorities of different types of data.

Some embodiments of the present disclosure ensure a smooth construction progress by controlling the transportation device to transport materials on time when the construction pipeline is in the pending construction stage. Furthermore, when the construction pipeline is in the under construction stage, controlling the alternative gas supply device to supply gas enables normal gas consumption for gas users and reduces gas safety risks. By adjusting the monitoring parameter, issues that arise during the construction process can be promptly identified and resolved. Additionally, adjusting the sizes of storage partitions of different types of data based on the monitoring parameter can prevent data loss due to exceeding storage space. Prioritizing the processing of different types of data allows the processor to handle the data in on time before it is overwritten.

It should be noted that the foregoing description of the process 200 is intended to be exemplary and illustrative only and does not limit the scope of application of the present disclosure. For a person skilled in the art, various corrections and changes may be made to process 200 under the guidance of the present disclosure.

FIG. 3 is a schematic diagram illustrating determining a material transportation instruction according to some embodiments of the present disclosure. As shown in FIG. 3, in some embodiments, the smart gas government supervision and management platform 110 may assess a traffic impact risk 330 of a construction pipeline based on construction information 310 and environmental data 320 and determine the material transportation instruction 340 based on the traffic impact risk 330.

The traffic impact risk characterizes an impact of a traffic factor on the timeliness of material transportation. In some embodiments, the traffic impact risk may be expressed as a numerical value, with a higher number indicating a higher traffic impact risk. In some embodiments, the traffic impact risk may also be expressed in other ways. For example, the traffic impact risk may be expressed as no risk, low risk, high risk, or the like.

In some embodiments, the processor may determine traffic congestion during the material transportation period based on the construction information 310 of the construction pipeline and the environmental data 320 of a construction supervision area. The more severe the traffic congestion, the greater the traffic impact risk 330. For example, if a certain batch of materials needs to be transported to a designated location 3 hours before construction, and the processor determines that traffic congestion is more severe 3 to 5 hours before construction based on the environmental data, the processor may set the traffic impact risk to a higher value (e.g., level 2). More descriptions regarding the construction information and the environmental data may be found in FIG. 2 and related descriptions thereof.

In some embodiments, the processor may generate a candidate transportation parameter based on the construction information and determine the traffic impact risk of a current construction pipeline by a risk assessment model when transporting materials based on the candidate transportation parameter.

The candidate transportation parameter is an alternative material transportation parameter that is pre-provided. The candidate transportation parameter includes a material transportation period, a material transportation volume, transportation configuration, or the like. More descriptions regarding the material transportation parameter may be found in FIG. 2 and related descriptions thereof.

In some embodiments, the candidate transportation parameter may include the material transportation parameter that may be selected for the material transportation of the current construction pipeline.

In some embodiments, the processor may select a period during which the materials may be transported as the material transportation period in the candidate transportation parameter based on a construction plan in the construction information. For example, the processor may select one or more periods before the planned construction time as the material transportation period in the candidate transportation parameter.

In some embodiments, the processor may determine the demand for the material as the material transportation volume in the candidate transportation parameter based on the construction plan in the construction information.

In some embodiments, the processor may determine the transportation configuration in the candidate transportation parameter based on a current dispatchable transportation resource (a total count of transportation vehicles, a total count of workers), and the material transportation volume.

In some embodiments, with lower transportation configuration, a plurality of round trips may be required to transport the materials, and the higher the number of transport trips, the higher the traffic impact risk. Thus, to reduce the traffic impact risk, a higher transportation configuration may be selected as much as possible.

The risk assessment model is a model used to assess the traffic impact risk of the construction pipeline. In some embodiments, the risk assessment model may be a machine learning model, such as a deep neural network (DNN) model, or the like.

An input of the risk assessment model may include the candidate transportation parameter, the construction information, and the environmental data. An output of the risk assessment model is the traffic impact risk of the construction pipeline under the candidate transportation parameter.

In some embodiments, the input of the risk assessment model further includes resource information corresponding to the dispatchable transportation resource and demand information corresponding to a material transportation need.

The dispatchable transportation resource is a resource that may be used for material transportation. For example, the dispatchable transportation resource may include trucks, lifting devices, workers, or the like.

The resource information corresponding to the dispatchable transportation resource is information related to the dispatchable transportation resource. For example, the resource information includes a count of spare transportation vehicles, a count of spare workers, or the like.

The material transportation need is a requirement that needs to be met for material transportation. The demand information corresponding to the material transportation need is information related to the material transportation need. In some embodiments, the demand information corresponding to the material transportation need includes information of materials to be transported.

The information of materials to be transported refers to information related to the material transportation volume, the transportation time, the destination of transportation, or the like, corresponding to the dispatchable transportation resource. For example, the information of materials to be transported may include information related to a pending transportation task for a particular transportation fleet.

In some embodiments, the processor may train an initial risk assessment model based on a plurality of first training samples with first labels to obtain the risk assessment model. The processor may input the first training samples into the initial risk assessment model, construct a loss function based on an output of the initial risk assessment model and the first labels, iteratively update parameters of the initial risk assessment model based on the loss function, and the model training is completed when the loss function satisfies a preset condition, then the trained risk assessment model is obtained. The preset condition may be that the loss function converges, a count of iterations reaches a threshold, or the like.

In some embodiments, the first training sample may include a sample transportation parameter, sample construction information, sample environmental data, sample resource information corresponding to a dispatchable transportation resource, and sample demand information corresponding to a material transportation need. The first training sample may be obtained based on historical data.

The first label may include the traffic impact risk corresponding to the first training sample. The first label may be determined based on an actual delivery time of the material and a specified time corresponding to the first training sample.

In some embodiments, the longer the actual delivery time of the material is later than the specified time, the higher the corresponding traffic impact risk level.

In some embodiments of the present disclosure, by combining the resource information corresponding to the dispatchable transportation resource and the demand information corresponding to the material transportation need to determine the traffic impact risk, the transportation of a plurality of materials may be coordinated, the dispatchable transportation resource is fully utilized, thus improving the efficiency of material transportation.

In some embodiments of the present disclosure, the risk assessment model is used to assess from various aspects to obtain the traffic impact risk, which can accurately reflect the advantages and disadvantages of different candidate transportation parameters and help to subsequently determine a more appropriate material transportation instruction to make the material transportation more timely.

In some embodiments, the processor may determine the material transportation instruction by querying a first preset table based on the traffic impact risk level to advance the material transportation period as well as to improve the transportation configuration. The first preset table includes a correspondence between the level of the traffic impact risk and the advancement of the material transportation period and the incremental increase in the transportation configuration, which may be determined based on historical experience.

In some embodiments, the processor may also determine the candidate transportation parameter meeting a preset condition as a target transportation parameter and determine the material transportation instruction based on the target transportation parameter.

The target transportation parameter is a material transportation parameter used for actual material transportation. In some embodiments, the preset condition may be that the traffic impact risk is minimized.

Some embodiments of the present disclosure may minimize the risk of the material transportation not arriving on time and ensure the smooth progress of construction by determining the candidate transportation parameter with the lowest traffic impact risk as the target transportation parameter.

Some embodiments of the present disclosure, based on the traffic impact risk, may determine the material transportation instruction that fully considers the impact of traffic factors on material transportation. By selecting the less risky transportation parameter for material transportation, the materials can be more reasonably allocated, thus avoiding slow construction progress due to delayed transportation.

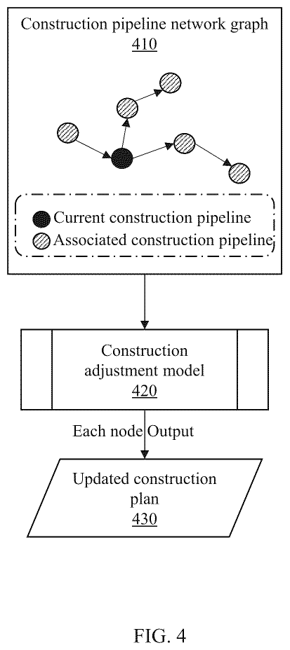

FIG. 4 is a schematic diagram illustrating updating a construction plan according to some embodiments of the present disclosure. As shown in FIG. 4, a process 400 includes the following steps. In some embodiments, an updated construction plan may be determined by a smart gas government supervision and management platform.

In some embodiments, in response to a traffic impact risk not meeting a first control condition, the smart gas government supervision and management platform may adjust a current construction plan of a construction pipeline based on the traffic impact risk and gas usage data and determine the updated construction plan. More descriptions regarding the gas usage data may be found in FIG. 2 and related descriptions thereof, and more descriptions regarding the traffic impact risk may be found in FIG. 3 and related descriptions thereof.

The first control condition is a condition used to determine whether material transportation may be completed on time. In some embodiments, the traffic impact risk may include whether the material transportation may be completed on time, and the first control condition may be that the material transportation may be completed on time.

In some embodiments, the first control condition may further include that at least one of the traffic impact risks corresponding to the material transportation periods of a plurality of candidate transportation parameters is less than a delay risk threshold, the delay risk threshold being artificially settable. Detailed descriptions regarding the material transportation periods may be found in FIG. 3 of the present disclosure.

The updated construction plan is a construction plan after updating at least one construction plan in the construction information of the gas pipeline. In some embodiments, the updated construction plan may include an updated project and updated information of the project.

In some embodiments, the smart gas government supervision and management platform may determine the updated construction plan based on the traffic impact risk and gas usage data in a plurality of ways.

In some embodiments, in response to the traffic impact risk not meeting the first control condition, the smart gas government supervision and management platform may determine, based on historical gas usage data, a plurality of alternative periods in which the gas usage volume is less than a preset value; select a period in which the traffic impact risk meets the first control condition as a new material transportation period by evaluating the traffic impact risk corresponding to each of the plurality of alternative periods utilizing a risk assessment model; calculate updated estimated arrival time of the materials based on the new material transportation period, determine updated construction time based on the updated estimated arrival time of the materials, and then determine the updated construction plan.

Detailed descriptions regarding the risk assessment model may be found in FIG. 3 of the present disclosure.

In some embodiments, the smart gas government supervision and management platform may obtain an associated construction pipeline and a material impact risk of the candidate transportation parameter; construct a construction pipeline network graph 410 based on associated construction information of the associated construction pipeline and associated construction data; and determine, based on the construction pipeline network graph 410, the updated construction plan 430 by a construction adjustment model 420.

The associated construction pipeline refers to other construction pipelines that are connected to the current construction pipeline.

In some embodiments, the smart gas government supervision and management platform may obtain the associated construction pipeline of the current construction pipeline through the construction information.

In some embodiments, the smart gas government supervision and management platform may construct the construction pipeline network graph based on the construction information, construction data of the current construction pipeline, the associated construction information, and the associated construction data of the associated construction pipeline.

The associated construction information refers to construction information corresponding to the associated construction pipeline, which includes but is not limited to, at least one of a code, a location, a construction volume (e.g., a length of the construction pipeline, etc.), a construction plan, and a construction progress of the associated construction pipeline.

The associated construction data refers to construction data corresponding to the associated construction pipeline, which includes but is not limited to, the current construction progress.

The construction pipeline network graph may be used to represent the construction scope and construction situation of the gas pipeline network.

In some embodiments, the construction pipeline network graph includes nodes and edges.

The nodes may characterize construction pipelines. In some embodiments, the nodes may include nodes characterizing the current construction pipeline and nodes characterizing the associated construction pipeline.

The nodes in the construction pipeline network graph have node characteristics. In some embodiments, the node characteristics corresponding to the nodes include traffic impact risks of a plurality of candidate transportation parameters corresponding to the construction pipeline, gas usage data in an area of gas outage caused by the construction pipeline, and gas pipeline construction information.

When adjusting the construction of the pipeline network, it is necessary to consider the traffic impact risks of the plurality of construction pipelines under their respective candidate transportation parameters. By setting a plurality of candidate transportation parameters, not only the execution plan of a single construction project is optimized, but also the smooth and safe operation of the entire construction pipeline network during transportation and construction processes is ensured. Thus, the construction progress is ensured to be advanced according to the plan, which effectively reduces traffic disruptions and construction costs.

The plurality of candidate transportation parameters may be obtained by referring to the description of FIG. 3.

The edges may characterize a temporal relationship between the construction of different construction pipelines. In some embodiments, the edges include connecting lines between construction pipelines connected in a construction sequence, with the edges oriented such that construction pipelines constructed first point toward construction pipelines constructed later.

The edges in the construction pipeline network graph have edge characteristics. In some embodiments, the edge characteristics may include a difference in scheduled construction time between construction pipelines corresponding to two nodes connected by an edge.

The difference in the scheduled construction time refers to a difference in the expected start time between two consecutive construction activities scheduled according to the construction plan. For example, if one construction task is scheduled to begin on Monday and the subsequent construction task is scheduled to begin on Wednesday, the difference in the scheduled construction time is two days.

When the traffic impact risk generated by pipeline construction exceeds a preset value, the material transportation period and the scheduled construction time may be adjusted to reduce the traffic impact risk and ensure the normal progress of the construction. By constructing the construction pipeline network graph, the material transportation period and the scheduled construction time may be adjusted while fully considering the construction sequence of different construction pipelines. This ensures the reduction of the traffic impact risk of the current construction pipeline and avoids disrupting the normal construction of other pipelines, thereby facilitating the timely completion of the overall construction plan.

In some embodiments, the smart gas government supervision and management platform may determine the updated construction plan based on the construction pipeline network graph through the construction adjustment model.

In some embodiments, the construction adjustment model may be a machine learning model. For example, the construction adjustment model may be a graphic neural network (GNN) model, or the like.

In some embodiments, an input of the construction adjustment model may include the construction pipeline network graph, and an output of the construction adjustment model may include the updated construction plan corresponding to the nodes.

In some embodiments, the smart gas government supervision and management platform may store the updated construction plan to the smart gas company management platform via the smart gas government supervision sensing network platform.

In some embodiments, the construction adjustment model may be trained by an initial construction adjustment model.

In some embodiments, a training sample includes a sample construction pipeline network graph, and the sample construction pipeline network graph is constructed based on historical construction data. A label corresponding to the training sample includes construction arrangement adjustment information corresponding to the sample construction pipeline network graph. The label may be obtained in a plurality of ways.

In some embodiments, the smart gas government supervision and management platform may determine actual construction arrangement adjustment information corresponding to the sample construction pipeline network graph based on the historical construction data and designate the actual construction arrangement adjustment information as the label of the training sample.

In some embodiments, the smart gas government supervision and management platform may obtain a historical adjustment plan and historical construction information corresponding to the sample construction pipeline network graph; determine an adjustment effect of the historical adjustment plan based on the historical construction information; optimize the historical adjustment plan based on the adjustment effect to obtain an optimized plan; and determine the label of the training sample based on the optimized plan.

The adjustment effect is an effect on the whole construction pipeline construction after adjusting the construction arrangement. Adjusting the construction arrangement may disrupt the original tight schedule, thus impacting the overall pipeline construction. For example, a delay in material transportation may lead to a backward adjustment of the construction time for a certain process, potentially causing subsequent delays and spare workers due to the untimely arrival of materials. As another example, if a delay in one process forces simultaneous delays in other processes that use the same resources (e.g., transportation vehicles or construction crews), this also constitutes the adjustment effect because it can lead to wasted resources, spare workers, and thus reducing overall construction efficiency.

In some embodiments, the adjustment effect may be determined based on one of a delay time of a historical construction pipeline, a worker spare time, and a device spare time. In some embodiments, the longer the delay, the greater the adjustment effect, and the longer the worker spare time and the longer the device spare time, the greater the adjustment effect.

In some embodiments, the delay may be determined based on a difference between an actual completion time and a planned completion time. The actual completion time and the planned completion time may be obtained based on historical actual construction information. The worker spare time and the device spare time may also be obtained based on the actual construction information.

In some embodiments, the smart gas government supervision and management platform may process the historical adjustment plan based on the adjustment effect of the historical adjustment plan to determine the label of the training sample.

In some embodiments, the historical adjustment plan in which the adjustment effect is less than an impact threshold may be unadjusted and used directly as a training label for training the initial construction adjustment model. The impact threshold may include at least one of a time threshold of construction with an overall delay based on the adjustment of the historical adjustment plan, a time threshold of the work spare time, and a time threshold of the device spare time, the specific value may be determined based on historical experience or actual construction needs.

When the adjustment effect is greater than the impact threshold, it characterizes that the overall progress of the construction may be significantly affected by the adjustment based on the historical adjustment plan, and the historical adjustment plan needs to be further optimized.

In some embodiments, when the adjustment effect of the historical adjustment plan is greater than the impact threshold, the smart gas government supervision and management platform may optimize the historical adjustment plan via S1˜S3 to obtain an optimized plan.

S1, generating all possible optional adjustment information subject to the constraint of a necessary sequence requirement.

The necessary sequence requirement includes that a process sequence cannot be changed, for example, the installation of the pipeline down the trench can only be done after the trench is dug. Additionally, the necessary sequence requirement may not be disrupted when generating the optional adjustment information.

All possible optional adjustment information refers to all potential construction arrangement adjustments. For example, materials of construction pipeline A may be transported before materials of construction pipeline B, and vice versa. Various possible transportation sequences of the materials of construction pipelines A and B are all possible optional adjustment information of material transportation of construction pipelines A and B.

In some embodiments, all possible optional adjustment information, subject to the necessary sequential requirement, may be obtained by the following operations.

A plurality of unconstrained construction arrangements are obtained by the smart gas government supervision and management platform based on permutations and combinations. Construction arrangements that do not satisfy the necessary sequential requirement are eliminated, and the remaining construction arrangements are all the possible optional adjustment information.

S2, calculating an estimated construction completion time corresponding to each optional adjustment information according to time requirements of various processes during pipeline construction.

In some embodiments, the time requirement of each process may be accumulated, to obtain the estimated construction completion time.

S3, determining optional adjustment information with the earliest estimated construction completion time as optimized construction arrangement adjustment information, which is used as the training label of the initial construction adjustment model.

The current construction plan of the construction pipeline is adjusted based on the traffic impact risk and the gas usage data, which enables the updated construction plan to flexibly adapt to actual traffic and changes in social demand. This effectively improves the adaptability and flexibility of the construction plan, reduces the interference of construction activities with traffic and social daily life, and optimizes the allocation and use of resources to enhance construction efficiency and safety.

FIG. 5 is a schematic diagram illustrating determining a gas supply regulation instruction according to some embodiments of the present disclosure. As shown in FIG. 5, process 500 includes the following steps. In some embodiments, the process 500 may be performed by a smart gas government supervision and management platform. More descriptions regarding the gas supply regulation instruction may be found in FIG. 2 and the related descriptions thereof.

In some embodiments, the smart gas government supervision and management platform may assess a gas construction risk 520 based on at least one of the construction information 310, the environmental data 320, and gas usage data 510. More descriptions regarding the gas usage data may be found in FIG. 2 and the related descriptions thereof.

The gas construction risk refers to a risk that may arise during the construction of a gas pipeline. In some embodiments, the gas construction risk may include a gas supply loss risk and a safety loss risk.

The gas supply loss risk refers to a risk of loss in gas supply due to gas pipeline construction. For example, the gas supply loss risk includes losses due to gas outage, or the like.

The safety loss risk refers to a risk of loss in gas safety due to gas pipeline construction. For example, the safety loss risk includes a risk of loss in terms of gas leakage, or the like. In some embodiments, the safety loss risk may include losses from the consequences of a leakage (e.g., losses caused by an explosion), or losses from resolving the leakage (e.g., incurred to troubleshoot and seal the leakage).

In some embodiments, the smart gas government supervision and management platform may determine a construction time 311 based on the construction information 310; determine a gas supply loss value of the construction time based on the construction time 311 and the gas usage data 510, and designate the gas supply loss value as the gas supply loss risk 521.

The construction time is a time period during which the gas pipeline may be constructed as determined by an actual construction plan.

In some embodiments, the construction time may be determined based on actual construction in the construction information. For example, the construction time may be obtained based on an actual construction progress in the construction information of the gas pipeline, as well as projected durations of different processes. For example, if a construction project includes three primary processes: excavation, pipe installation, and backfill, where the excavation is expected to take 3 days, the pipe installation is expected to take 5 days, and the backfill is expected to take 2 days, then the entire construction time is from the first day of excavation to the last day of backfill completion. If the construction project starts on the first day of the month, the construction time may be from the 1st to the 10th, totaling 10 days.

In some embodiments, the gas supply loss value may be obtained by querying the gas usage data for the gas usage volume corresponding to the construction time. For example, the smart gas government supervision and management platform may query historical gas usage data within a preset time interval, for the gas usage volume for the period of 2:00 p.m.-6:00 p.m. each day. An average daily gas usage volume is determined based on an average of the gas usage volume, and the gas usage volume during the construction time is determined based on the average daily gas usage volume and the construction time.

In some embodiments, the smart gas government supervision and management platform may designate the gas usage volume during the construction time as the gas supply loss value.

In some embodiments, the gas supply loss risk is also related to the traffic impact risk, and the smart gas government supervision and management platform may determine transportation delay information based on the traffic impact risk; determine an estimated gas outage time based on the transportation delay information; and determine the gas supply loss risk based on the estimated gas outage time and the gas usage data.

The transportation delay information refers to a delay situation in material transportation. For example, if a transportation route is frequently delayed due to traffic control, and an average delay time is 30 minutes, the average delay time may be noted as the transportation delay information of that transportation route.

In some embodiments, the smart gas government supervision and management platform may query a historical late duration of the corresponding material transportation in the historical data based on the traffic impact risk and designate the historical late duration as the transportation delay information.

Detailed descriptions regarding the traffic impact risk and its determination may be found in the relevant description in FIG. 3 of the present disclosure.

The estimated gas outage time is an estimated time period during which the outage may occur due to the malfunction of the gas pipeline. In some embodiments, the estimated gas outage time may include a suspension of the gas supply due to ongoing construction, as well as a suspension of the gas supply due to a delay in materials resulting in a pause in construction when the gas pipeline cannot function properly.

In some embodiments, the smart gas government supervision and management platform may predict a delayed construction duration based on the transportation delay information and the construction time and designate the delayed construction time as the estimated gas outage time.

The delayed construction duration is a construction time that is delayed due to the delay in material transportation.

In some embodiments, the smart gas government supervision and management platform may query the historical gas usage data for a gas usage volume corresponding to the estimated gas outage time and designate the gas usage volume during the estimated gas outage time as the gas supply loss risk. The manner of determining the gas usage volume during the estimated gas outage time is similar to that of determining the gas usage volume during the construction time, as can be seen in the preceding description.

Based on the traffic impact risk, determining the estimated gas outage time, and thus the gas supply loss risk, may adequately take into account the impact of untimely material transportation on the construction time, and thus more accurately determine the gas supply loss risk.

In some embodiments, the smart gas government supervision and management platform may determine, based on the construction information 310, a safety risk node 312 of the gas pipeline; determine pedestrian flow data 321 and traffic flow data 322 of the construction time based on the environmental data 320; and determine, based on the safety risk node 312, the pedestrian flow data 321, and the traffic flow data 322, the safety loss risk 522 by matching in a safety database.

In some embodiments, the safety risk node is a point and/or process where a safety risk exists. For example, the safety risk node may be a point where a newly installed pipe interfaces with an old pipe, where a pipe is welded, or the like.

In some embodiments, the smart gas government supervision and management platform may preset a safety risk attribute for at least one point in the construction gas pipeline based on historical experience and automatically determine the safety risk node based on the preset safety risk attribute.

The safety risk attribute is a characteristic used to determine whether there is a safety risk at a point in a gas pipeline. If a point has a safety risk attribute, there is a safety risk. For example, if the safety risk attribute includes welding operations, newly installed pipeline access to the pipeline network, or the like, then processes and points with welding operations and newly installed pipeline access to the pipeline network are safety risk nodes.

The pedestrian flow data refers to a count of pedestrians passing near the construction pipeline per unit of time during the construction time.

The traffic flow data refers to a count of vehicles passing near the construction pipeline per unit of time during the construction time.

In some embodiments, the smart gas government supervision and management platform may determine the pedestrian flow data and the traffic flow data based on the environmental data. More descriptions regarding the environmental data may be found in FIG. 2 and related descriptions thereof.

In some embodiments, the smart gas government supervision and management platform may determine the safety loss risk by vector matching. For example, the smart gas government supervision and management platform may construct a safety risk vector 530 based on the safety risk node 312, the pedestrian flow data 321, and the traffic flow data 322 corresponding to the construction pipeline, search in a safety database based on the safety risk vector 530 to find a reference vector that is closest in distance to the safety risk vector 530, designate the reference vector as a target reference vector, and designate a reference safety loss corresponding to the reference safety loss as the safety loss risk of the construction pipeline.

The safety database includes at least one reference vector and a reference safety loss corresponding to each reference vector. The reference vector is constructed based on a historical safety risk node, historical pedestrian flow data, and historical traffic flow data in historical data.

The reference safety loss refers to the loss caused by an actual safety issue in the historical data, e.g., at least one of a gas loss, an economic loss, and a disposal cost loss.

In some embodiments, the smart gas government supervision and management platform may determine at least one similar reference vector by matching in the safety database and determine the safety loss risk 522 based on a reference weight of each of the at least one similar reference vector.

In some embodiments, the smart gas government supervision and management platform may match the safety risk vector in the safety database and designate the reference vector with the top-ranked similarity (e.g., the top five, the top ten, or the like) or those with a similarity exceeding a similarity threshold as the similar reference vector, and determine the safety loss risk based on each reference weight corresponding to at least one similar reference vector.

The similarity may be represented by a vector distance between the safety risk vector and the reference vector, and the similarity threshold may be a distance threshold. The smaller the vector distance, the higher the similarity between the two vectors. In some embodiments, the similarity threshold may be determined based on historical experience and/or practical needs.

In some embodiments, the reference weight may be determined based on the similarity between the similar reference vector and the safety risk vector, and a safety accident level corresponding to the similar reference vector. The higher the similarity between the similar reference vector and the safety risk vector, and the higher the safety accident level corresponding to the similar reference vector, the higher the corresponding reference weight.

In some embodiments, the safety loss risk may be determined by weighting and summing a plurality of similar reference vectors corresponding to a reference safety loss according to the reference weight.

By determining the plurality of similar reference vectors and performing a weighted summation based on the reference weights, the safety loss risk corresponding to the construction pipeline is determined, the safety loss risk may be more accurately assessed, thus providing a more reliable reference for determining the gas supply regulation instruction.

In some embodiments, the smart gas government supervision and management platform may determine a gas supply regulation instruction 560 based on the gas construction risk 520.

In some embodiments, the smart gas government supervision and management platform may determine the gas supply regulation instruction by comparing the magnitude of the gas supply loss risk to the safety loss risk.

In some embodiments, if a large gas usage volume during the construction time leads to the gas supply loss risk greater than the safety loss risk, the smart gas government supervision and management platform may generate an emergency gas supply instruction as the gas supply regulation instruction, and the emergency gas supply instruction may include emergency gas supply to users via an emergency gas supply vehicle.

In some embodiments, if the safety loss risk is greater than the gas supply loss risk, the smart gas government supervision and management platform may lower the gas supply pressure and other parameters of the nearby gas pipeline during the construction time, or stop the gas supply (i.e., lower the gas supply pressure to zero) during off-peak gas period, to reduce gas leakage and thus mitigate safety hazards.

In some embodiments, in response to the gas construction risk 520 not meeting a second control condition 540, the smart gas government supervision and management platform may determine an emergency gas supply parameter 550 based on gas pipeline network information and determine the gas supply regulation instruction 560 based on the emergency gas supply parameter 550.

The second control condition refers to a condition for determining whether an alternative gas supply needs to be arranged. For example, the second control condition may be that the gas supply loss risk exceeds a gas supply loss risk threshold or that the safety loss risk exceeds a safety loss risk threshold. The gas supply loss risk threshold and the safety loss risk threshold may be determined based on historical experience and/or actual needs.

The emergency gas supply parameter is a gas supply parameter that is used to reduce the gas construction risk, for example, to adjust the gas supply pressure, the gas supply flow rate, the gas supply time period, the gas supply manner, or the like. The gas supply manner may include supplying gas by an emergency gas supply truck, an emergency gas supply tank, or the like.

In some embodiments, when the gas supply loss risk meets the second control condition, the emergency gas supply parameter may include increasing the gas supply parameter of the parallel gas pipeline/field station, such as increasing the gas supply pressure, flow rate, or the like, to supply gas to the affected area through the parallel gas pipeline/field station, to restore the gas supply to the affected area to normal.

The parallel gas pipeline/field station refers to a gas pipeline/field station that is juxtaposed and connected with a construction pipeline so that when the construction pipeline is unable to supply gas, the gas from the juxtaposed gas pipeline/field station may serve as an alternative or supplement to ensure the gas supply to gas users in the affected area.

In some embodiments, when the safety loss risk meets the second control condition, the gas supply parameter, such as the gas supply pressure, gas flow rate, or the like, of a nearby gas pipeline may be adjusted to reduce gas leakage and mitigate the safety loss risk.

In some embodiments, the smart gas government supervision and management platform may adjust the second control condition based on a change in construction arrangement for each construction pipeline in an updated construction plan.

The change in the construction arrangement refers to a change in the updated construction arrangement of the construction pipeline compared to the original planned construction arrangement. In some embodiments, the change in the construction arrangement includes at least one of a change in a construction time for different processes, a change in construction duration, a change in completion time, or the like.

In some embodiments, the smart gas government supervision and management platform may adjust at least one of the gas supply loss risk threshold or the safety loss risk threshold in the second control condition based on construction changes.

In some embodiments, when the construction time is adjusted from a low gas consumption peak to a high gas consumption peak, the smart gas government supervision and management platform may lower the safety loss risk threshold to enhance the risk control of gas safety.

Due to the adjustment of the construction time to the peak period, the possibility of gas leakage may increase, and due to the high flow and elevated air pressure, the gas leakage volume is increased while a pedestrian flow is high. Then, the smart gas government supervision and management platform may lower the safety loss risk threshold to ensure that the safety risk is contained within a lower range.

In some embodiments, the smart gas government supervision and management platform may lower the gas supply loss risk threshold when the construction duration increases and the completion time is delayed, to control the growth of the gas supply loss situation as much as possible.

When the construction time extends and the completion is delayed, the impact on the gas supply period is prolonged. At this point, the smart gas government supervision and management platform may reduce the gas supply loss threshold and ensure the gas supply to users by promptly arranging the alternative gas supply.

By assessing the gas construction risk based on the construction information, the environmental data, and the gas usage data, the gas supply regulation instruction of the construction supervision area is generated, enabling the gas supply system to accurately respond to the risks brought by construction activities. Not only the safety and stability of gas supply during construction is ensured, but also the gas supply volume and supply strategy is adjusted according to the actual situation, effectively avoiding excess or insufficient gas supply, and improving the efficiency and economy of gas supply.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and amendments are intended to be suggested by this disclosure and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment”, “one embodiment”, or “an alternative embodiment” in various portions of the present disclosure are not necessarily all referring to the same embodiment. In addition, some features, structures, or characteristics of one or more embodiments in the present disclosure may be properly combined.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In closing, it is to be understood that the embodiments of the present disclosure disclosed herein are illustrative of the principles of the embodiments of the present disclosure. Other deformations that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for monitoring smart gas pipeline network construction, wherein the method is performed by a smart gas government supervision and management platform of an Internet of Things (IoT) system for monitoring smart gas pipeline network construction, and the method comprises:
obtaining update situation of construction information corresponding to a construction pipeline in a construction supervision area, and obtaining, in response to determining that the construction information is updated, supervisory data of the construction supervision area;
storing the supervisory data in a government supervisory integrated database of the smart gas government supervision and management platform according to a preset rule, the government supervisory integrated database being configured as a memory, wherein
the supervisory data includes the construction information, environmental data of the construction supervision area, and gas usage data of a pipeline to be constructed in the construction supervision area;
determining a construction state of the construction pipeline;
in response to the construction state meeting a first condition,
generating a material transportation instruction for the construction pipeline based on the construction information and the environmental data; and
sending the material transportation instruction to a transportation device to control the transportation device to transport material according to a material transportation parameter;
in response to the construction state meeting a second condition,
generating a gas supply regulation instruction of the construction supervision area based on at least one of the construction information, the environmental data, and the gas usage data; and
sending the gas supply regulation instruction to a smart gas equipment object platform corresponding to the construction supervision area to control a gas supply parameter in the construction supervision area;
obtaining a first update frequency of the material transportation instruction and a second update frequency of the gas supply regulation instruction from the government supervisory integrated database;
adjusting a current monitoring parameter of the smart gas equipment object platform based on the first update frequency and the second update frequency;
allocating a size of a storage partition occupied by the supervisory data and gas safety data in the government supervisory integrated database based on an adjusted monitoring parameter; and
determining a priority of calculating resource allocation when a processor of the smart gas government supervision and management platform processes different types of data.

2. The method of claim 1, wherein the IoT system for monitoring smart gas pipeline network construction further includes a smart gas government supervision sensing network platform, a smart gas government supervision object platform, a smart gas company sensing network platform, the smart gas equipment object platform, and a gas user object platform;
the smart gas government supervision and management platform includes the government supervisory integrated database; and
the smart gas government supervision object platform includes a smart gas company management platform.

3. The method of claim 1, wherein the generating a material transportation instruction for the construction pipeline based on the construction information and the environmental data includes:
assessing a traffic impact risk of the construction pipeline based on the construction information and the environmental data, wherein the traffic impact risk characterizes an impact of a traffic factor on a timeliness of material transportation; and
determining the material transportation instruction based on the traffic impact risk.

4. The method of claim 3, wherein the assessing a traffic impact risk of the construction pipeline based on the construction information and the environmental data, includes:
generating a candidate transportation parameter based on the construction information; and
determining the traffic impact risk of a current construction pipeline by a risk assessment model when transporting materials based on the candidate transportation parameter, the risk assessment model being a machine learning model.

5. The method of claim 4, wherein an input of the risk assessment model further includes resource information corresponding to a dispatchable transportation resource and demand information corresponding to a material transportation need.

6. The method of claim 4, wherein the determining the material transportation instruction based on the traffic impact risk includes:
determining the candidate transportation parameter meeting a preset condition as a target transportation parameter; and
determining the material transportation instruction based on the target transportation parameter.

7. The method of claim 3, further comprising:
in response to the traffic impact risk not meeting a first control condition, adjusting a current construction plan of the construction pipeline based on the traffic impact risk and the gas usage data and determining an updated construction plan; and
storing the updated construction plan into the smart gas company management platform.

8. The method of claim 7, wherein the adjusting a current construction plan of the construction pipeline based on the traffic impact risk and the gas usage data and determining an updated construction plan includes:
obtaining an associated construction pipeline and a material transportation risk of the candidate transportation parameter;
constructing a construction pipeline network graph based on associated construction information of the associated construction pipeline and associated construction data; and
determining, based on the construction pipeline network graph, the updated construction plan by a construction adjustment model, the construction adjustment model being a machine learning model.

9. The method of claim 8, wherein the construction adjustment model is obtained by training an initial adjustment model; wherein
a training sample includes a sample construction pipeline network graph, and the sample construction pipeline network graph is constructed based on historical construction data; and
the method further comprises:
obtaining a historical adjustment plan and historical construction information corresponding to the sample construction pipeline network graph;
determining an adjustment effect of the historical adjustment plan based on the historical construction information;
optimizing the historical adjustment plan based on the adjustment effect to obtain an optimized plan; and
determining a label of the training sample based on the optimized plan.

10. The method of claim 1, wherein the generating a gas supply regulation instruction of the construction supervision area based on at least one of the construction information, the environmental data, and the gas usage data includes:
assessing a gas construction risk based on at least one of the construction information, the environmental data, and the gas usage data, the gas construction risk including at least one of a gas supply loss risk and a safety loss risk; and
determining the gas supply regulation instruction based on the gas construction risk.

11. The method of claim 10, wherein the assessing a gas construction risk based on at least one of the construction information, the environmental data, and the gas usage data includes:
determining a construction time based on the construction information; and
determining a gas supply loss value of the construction time based on the construction time and the gas usage data and using the gas supply loss value as the gas supply loss risk.

12. The method of claim 11, wherein the construction time is also related to a traffic impact risk; and
the method further comprises:
determining transportation delay information based on the traffic impact risk, the transportation delay information characterizing a delay in material transportation;
determining an estimated gas outage time based on the transportation delay information; and
determining the gas supply loss risk based on the estimated gas outage time and the gas usage data.

13. The method of claim 10, wherein the assessing a gas construction risk based on at least one of the construction information, the environmental data, and the gas usage data includes:
determining a safety risk node of a gas pipeline based on the construction information;
determining pedestrian flow data and traffic flow data of the construction time based on the environmental data; and
determining, based on the safety risk node, the pedestrian flow data, and the traffic flow data, the safety loss risk by matching in a safety database.

14. The method of claim 13, wherein the determining, based on the safety risk node, the pedestrian flow data, and the traffic flow data, the safety loss risk by matching in a safety database includes:
constructing a safety risk vector based on the safety risk node, the pedestrian flow data, and the traffic flow data;
determining, based on the safety risk vector, at least one similar reference vector by matching in the safety database; and
determining the safety loss risk based on a reference weight of each of the at least one similar reference vector, wherein the reference weight is determined based on a similarity between the similar reference vector and the safety risk vector, and a safety accident level of the similar reference vector.

15. The method of claim 10, wherein the determining the gas supply regulation instruction based on the gas construction risk includes:
in response to the gas construction risk not meeting a second control condition, determining an emergency gas supply parameter based on gas pipeline network information; and
determining the gas supply regulation instruction based on the emergency gas supply parameter.

16. The method of claim 15, further comprising:
adjusting the second control condition based on a change in construction arrangement for each construction pipeline in an updated construction plan.

17. An Internet of Things (IoT) system for monitoring smart gas pipeline network construction, wherein the IoT system includes a smart gas government supervision and management platform, a smart gas government supervision sensing network platform, a smart gas government supervision object platform, a smart gas company sensing network platform, a smart gas equipment object platform, and a gas user object platform; wherein
the smart gas government supervision and management platform includes a government supervisory integrated database;
the smart gas government supervision object platform includes a smart gas company management platform;
the smart gas government supervision and management platform is configured to:
obtain update situation of construction information corresponding to a construction pipeline in a construction supervision area, and obtain, in response to determining that the construction information is updated, supervisory data of the construction supervision area;
store the supervisory data in a government supervisory integrated database of the smart gas government supervision and management platform according to a preset rule, the government supervisory integrated database being configured as a memory, wherein
the supervisory data includes the construction information, environmental data of the construction supervision area, and gas usage data of a pipeline to be constructed in the construction supervision area;
determine a construction state of the construction pipeline;
in response to the construction state meeting a first condition,
generate a material transportation instruction for the construction pipeline based on the construction information and the environmental data; and
send the material transportation instruction to a transportation device to control the transportation device to transport material according to a material transportation parameter;
in response to the construction state meeting a second condition,
generate a gas supply regulation instruction of the construction supervision area based on at least one of the construction information, the environmental data, and the gas usage data; and
send the gas supply regulation instruction to a smart gas equipment object platform corresponding to the construction supervision area to control a gas supply parameter in the construction supervision area;
obtain a first update frequency of the material transportation instruction and a second update frequency of the gas supply regulation instruction from the government supervisory integrated database;
adjust a current monitoring parameter of the smart gas equipment object platform based on the first update frequency and the second update frequency;
allocate a size of a storage partition occupied by the supervisory data and gas safety data in the government supervisory integrated database based on an adjusted monitoring parameter; and
determine a priority of calculating resource allocation when a processor of the smart gas government supervision and management platform processes different types of data.

18. The IoT system of claim 17, wherein the smart gas government supervision and management platform is further configured to:
assess a traffic impact risk of the construction pipeline based on the construction information and the environmental data, wherein the traffic impact risk characterizes an impact of a traffic factor on a timeliness of material transportation; and
determine the material transportation instruction based on the traffic impact risk.

19. The IoT system of claim 18, wherein the smart gas government supervision and management platform is further configured to:
in response to the traffic impact risk not meeting a first control condition, adjust a current construction plan of the construction pipeline based on the traffic impact risk and the gas usage data and determine an updated construction plan; and
store the updated construction plan into the smart gas company management platform.

20. The IoT system of claim 17, wherein the smart gas government supervision and management platform is further configured to:
assess a gas construction risk based on at least one of the construction information, the environmental data, and the gas usage data, the gas construction risk including at least one of a gas supply loss risk and a safety loss risk; and
determine the gas supply regulation instruction based on the gas construction risk.
